(19) United States
(12) Patent Application Publication
(10) Pub. No.: US 2016/0201153 A1
(43) Pub. Date: Jul. 14, 2016

(54) APPARATUS AND METHOD FOR STRETCHING A PELT ON A PELT BOARD

(71) Applicant: JASOPELS A/S, Bording (DK)

(72) Inventor: Kurt Pedersen, Vinderup (DK)

(21) Appl. No.: 14/913,674

(22) PCT Filed: Aug. 7, 2014
(86) PCT No.: PCT/EP2014/066963

§ 371 Date: Feb. 22, 2016

(30) Foreign Application Priority Data
Aug. 22, 2013 (DK) PA2013 70460

(51) Int. Cl. C14B 15/06

(52) U.S. Cl. CPC C14B 15/06

(57) ABSTRACT

An apparatus is disclosed for stretching a pelt (1) on a pelt board (2) comprising a pelt board holder (10) for holding one end part (4) of the pelt board (2), pelt holders (5) arranged to grip at least a part of the lower periphery of the pelt (1) when arranged on the pelt board (2), driver (11) for mutually displacing the pelt board (2) placed in the pelt board holder (10) and the pelt holders (5) in a longitudinal direction of the pelt board (2) so as to stretch the pelt (1), and controller (12) arranged to control the operation of the driver (11), where the controller is configured to reduce the speed with which the pelt (1) is stretched by means of the driver (11) during stretching of the pelt (1). Furthermore is disclosed a method of stretching pelts (1) accordingly.

The present invention relates to an apparatus and a method for stretching a pelt of a furred animal, in particular of a mink, prior to the drying of the pelt.

### BACKGROUND

It has been common practice to stretch pelts out before drying them in order to obtain a desired size of the pelt and a wrinkleless leather part of the pelt. For pelts of bred furred animals, in particular mink and fox, the pelt is usually stretched on a pelt board and secured to that prior to the drying. The individual pelt is stretched with individual force to an individual length depending on the size and the sex of the animal and other qualities of the unstretched pelt.

Danish patent No. DK 169 525 discloses a machine for stretching of pelts on pelt boards, where a first stretch force is applied to stretch the pelt and, in case it is detected that the pelt length is close to the next higher classification size, a second, higher stretch force is applied to the pelt.

International patent application No. WO 02/44428 discloses a further development of this machine by adding a vibrating movement to the pelt during the stretching thereof, whereby an increased stretching of the pelt is achieved without causing damages to the pelt.

In the international patent application No. WO 2005/028682 a device for stretching of pelts is disclosed, where holding elements are provided to grip, engage and fasten the pelt along the whole periphery of the lower end of the pelt, thereby applying the stretch force more uniformly to the pelt and allowing for an increased stretching thereof. The pelt is secured in the stretched position by means of a sleeve drawn over the fur side of the pelt from a tip of the pelt board, i.e. from the nose end of the pelt.

One method of securing the pelt to the pelt board after stretching is disclosed in international application No. WO 01/62985 in which a sleeve is drawn over and around the pelt board and the pelt from the nose end of the pelt board, such that the internal side walls of the sleeve are in contact with the fur side of the pelt.

In the international patent application No. WO 2005/080607 the pelt is secured to the pelt board after stretching of the pelt by means of a winding material, such as a band, which is wound around the lower end part of the pelt, i.e. near the tail part.

In the international patent application No. WO 2012/126467 A1, the maximum force with which the apparatus stretches the pelt is determined for the individual pelt from the length of the pelt prior to stretching thereof. It is also disclosed to decrease the stretching force to reduce the length of the stretched pelt to the nearest shorter classification size length and thereby improving the quality of the pelt.

The object of the present invention is to improve the stretching of the pelts, in particular the mink pelts for increasing the number of pelts that are stretched to an optimal length.

### BRIEF DESCRIPTION OF THE INVENTION

The inventor has found that a pelt may be stretched somewhat further than usual by controlling the stretching process so that the last part of the stretching is conducted with a reduced speed which allows the pelt to give and stretch a bit more without being torn or otherwise harmed. The whole stretching process could of course be performed at a substantially constant low stretching speed but that would cause the process to be too slow and occupy the apparatus too long time for stretching of each pelt.

Thus, the present invention relates to an apparatus for stretching a pelt on a pelt board comprising a pelt board holder for holding one end part of the pelt board, pelt holders arranged to grip at least a part of the lower periphery of the pelt when arranged on the pelt board, driver for mutually displacing the pelt board placed in the pelt board holder and the pelt holders in a longitudinal direction of the pelt board so as to stretch the pelt, and controller arranged to control the operation of the driver so as to reduce the speed with which the pelt is stretched by means of the driver during stretching of the pelt.

The reduced speed is preferably lower than 250 millimetres per second, such as in the range of 10 to 100 millimetres per second, in particular in the range of 30 to 80 millimetres per second. The stretching speed prior to the speed reduction is typically in the range of 350 to 500 millimetres or even higher.

The controller may be is configured to reduce the speed with which the pelt is stretched in a step-wise manner. Alternatively, the controller may be configured to reduce the speed with which the pelt is stretched in a down-ramping manner, where at least the last part of the ramping of the stretching speed reaches a reduced speed lower than 250 millimetres per second, such as in the range of 10 to 100 millimetres per second, in particular in the range of 30 to 80 millimetres per second.

It is preferred that the controller is arranged to control the operation of the driver to stretch the pelt with a first, substantially constant speed, followed by a reduction of the stretching speed.

It is preferred that the apparatus comprises at least one detector for detection of at least one parameter associated with the stretching of the pelt and providing an output to the controller, wherein the controller is configured to reduce the speed with which the pelt is stretched in response to said detected parameter(s).

In particular, said at least one detector(s) may be arranged to detect said parameter(s) is/are repeatedly during the stretching of a pelt such as in a continuous manner.

One of said parameters may in a preferred embodiment be indicative of the current force with which the pelt is being stretched. The parameter is in one embodiment the current fed to an electric motor driving the stretching of the pelt on the pelt board. Alternatively, a dedicated force detector such as a weighing cell may be installed in the apparatus to provide the output to the controller.

In another embodiment, one of said parameters is indicative of the time during which the pelt has been stretched, such that the stretching speed e.g. is reduced after a certain predetermined stretching time has passed.

Alternatively or additionally, one of said parameters may be indicative of the current length of the stretched pelt, such that the speed e.g. may be reduced after a certain predetermined length has been reached. The length may e.g. be predetermined from the sex of the animal from which the pelt comes and/or the length of the pelt prior to stretching thereof.

It is preferred that the controller is arranged to reduce said speed selectively in response to said detected parameter(s), such that the speed is not reduced for all pelt but only selectively, such that the stretching of some pelts, based on said detected parameters, may be stopped and the pelt fixed to the pelt board or even reversed to reached the closest lower classification size length of the pelt before the pelt is fixed to the pelt board.

In a particular preferred embodiment the apparatus comprises a length detector for detecting a parameter indicative of the current length of the pelt and providing an output accordingly to the controller, wherein the controller is configured to control a first stretching of the pelt by means of the driver and to selectively continuing the stretching of the pelt with a reduced speed relative to the speed with which the pelt was stretched prior to the continued stretching based on said parameter indicative of the current length of the stretched pelt.

The controller may for this embodiment be configured to continuing the stretching in case the difference between the current length and a selected classification size length is less than a predefined length difference limit, the classification size length being selected from a plurality of predefined classification size lengths as the one being the least longer than the current length. The classification size lengths for mink pelts are mutually spaced with 60 millimetres, and the length difference limit is preferably 20 to 40 millimetres, such as about 30 millimetres.

The apparatus may for this embodiment further comprise a force detector for detecting a parameter indicative of the current stretching force applied to the pelt by means of the driver and providing an output accordingly to the controller as discussed previously, wherein the controller is configured to selectively continuing the stretching of the pelt based on said parameter indicative of the current length of the stretched pelt when a defined stretching force has been applied to the pelt. The controller may in particular be configured to obtain said defined stretching force for a pelt from a measurement of the length of the pelt before stretching thereof.

The driver is in a preferred embodiment an electric actuator of which the speed is readably controllable and the force indicator is preferably the current fed to the driver.

The present invention furthermore relates to a method of stretching a pelt arranged on a pelt board supported at an end part by a pelt board holder, the method comprising the steps of gripping the lower periphery of the pelt by means of pelt holders, mutually displacing the pelt board holder and the pelt holders in a longitudinal direction of the pelt board by means of a driver so as to stretch the pelt, and controlling the stretching of the pelt by means of a controller arranged to control the operation of the driver so that the speed with which the pelt is stretched is reduced during stretching of the pelt.

The method comprises preferably the steps of conducting a first stretching of the pelt, preferably with a substantially constant first stretching speed, and selectively continuing the stretching of the pelt with a reduced speed relative to the speed with which the pelt was stretched prior to the continued stretching based on a parameter indicative of the current length of the stretched pelt.

The stretching may in particular be continued in case the difference between the current length and a selected classification size length is less than a predefined length difference limit, the classification size length being selected from a plurality of predefined classification size lengths as the one being the least longer than the current length.

The method is preferably applied to mink pelts.

### BRIEF DESCRIPTION OF THE DRAWING

An embodiment of the present invention is shown in the enclosed drawing of which

FIG. 1 is a schematic front view of a stretching apparatus with a pelt board and a pelt,

FIG. 2 is a diagram showing the stretching speed versus the stretched length of the pelt for prior art as well as different embodiments of the present invention,

FIG. 3 is a diagram showing the stretching speed versus the stretched length of the pelt according to a specific embodiment of the present invention, and

FIG. 4 is a flowchart illustrating an embodiment of the present invention.

### DETAILED DESCRIPTION OF THE EMBODIMENT

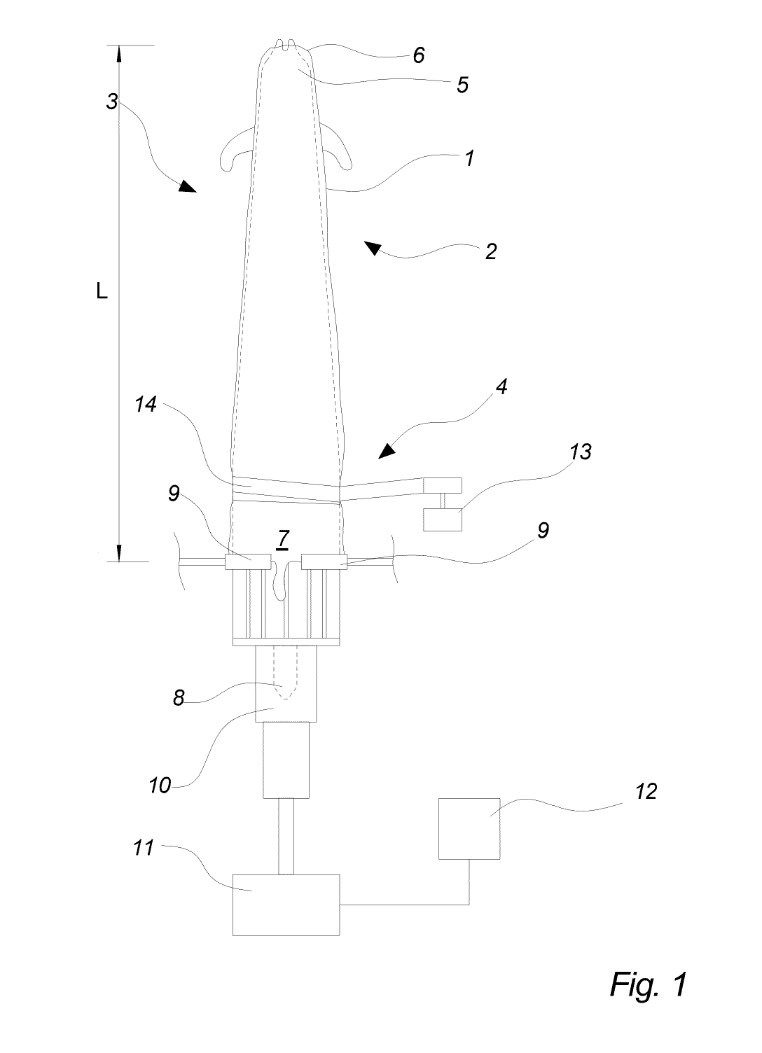

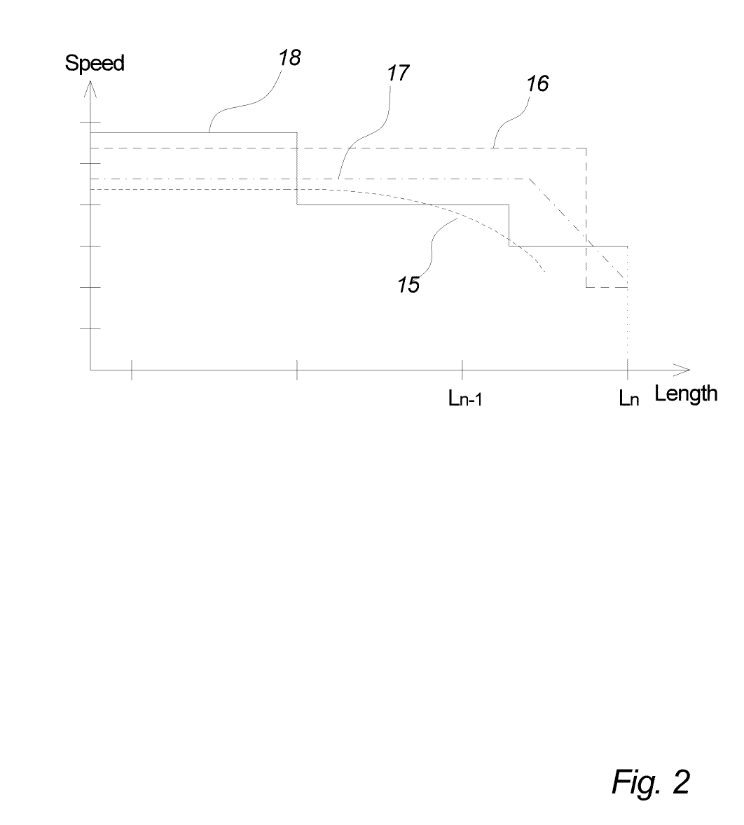

The stretching apparatus according to an embodiment of the invention is shown in FIGS. 1 and 2 for stretching of a fresh pelt 1 of a furred animal, in particular of a mink, for the purpose of drying the pelt 1 in the stretched position. The pelt 1 is arranged on a pelt board 2 which in itself is well-known in several variations, such as the traditional wooden pelt boards 2 and the newer hollow pelt boards 2 where drying air is distributed from the interior of the pelt board 2 through openings in the sides of the board. The fur side of the pelt 1 is on the exterior whereas the skin side, also known as the flesh side, is facing inwards towards the surface of the pelt board 2. The pelt board 2 has an upper, tapering part 3 and a lower, thick end part 4 of a substantially constant cross-section and the pelt 1 is drawn onto the pelt board 2 from the tip 5 of the tapering part 3 so that the nose end 6 of the pelt 1 is arranged at the tip 5 and the tail end 7 of the pelt 1 is situated typically near the transition between the tapering part 3 and the end part 4 of the pelt board 2. The lower end 4 of the pelt board is equipped with a projecting element 8, which for a number of expandable pelt boards 2 can be displaced in the longitudinal direction of the pelt board 2 to or from the lower end 4 in order to expand or contract the pelt board 2, respectively.

The apparatus is equipped with pelt holders 9 for gripping and retaining a lower periphery of the pelt 1, the pelt holders 9 being of a well-known design in the art. The projecting element 8 of the pelt board 2 is placed in a pelt board holder 10 that is formed with an opening to accommodate the projecting element 8 and a driver 11 is connected to the pelt board holder 10 to drive the pelt board holder 10 and thus the pelt board 2 towards the stationary pelt holders 9 gripping the lower periphery of the pelt 1, whereby the pelt 1 is stretched on the pelt board 2. The driver 11 is of the electric linear actuator type, and the maximum force of the driver 11 is controlled by a controller 12 by monitoring the current I in the motor of the driver 11. The maximum stretching force and hence the maximum current Iₘₐₓ is determined by the controller for the individual pelt 1, preferably from the length of the pelt 1 prior to stretching thereof as disclosed in WO 2012/126467 A1. The maximum force may alternatively be controlled partly or fully by the operator of the apparatus.

When the pelt 1 is stretched to its desired length, a fixing strip applier 13 is activated to wrap a fixing strip 14 around a lower part of the pelt 1 in order to fix the pelt 1 in the stretched position to the pelt board 2 such that the pelt 1 will remain in position during drying thereof. In alternative embodiments, the pelt 1 may be fixed by means of a sleeve that is drawn over the tip 5 of the pelt board 2 and down to the lower part of the pelt 1, where is clamps the pelt 1 to the pelt board 2 as disclosed in e.g. WO 01/62985 A1, or the pelt 1 may be fixed by means of stables applied through the pelt 1 and into a wooden pelt board 1.

The distance between the pelt holder 9 and the pelt board holder 10 before and after stretching of the pelt 1 is used by the controller 12 to compute the length of the unstretched pelt 1 and the stretched pelt 1, respectively, the length of the unstretched pelt 1 being applied to determine the maximum force with which the driver 11 drives the pelt board holder 10 towards the pelt holders 9 for stretching the pelt 1, and the length of the stretched pelt 1 is used for keeping statistics of the pelts 1 being stretched and fixed to pelt boards 2 by the apparatus.

In the prior stretching apparatus, the driver 11 comprised an pneumatic linear actuator to which a given air pressure was provided, resulting in a substantially constant stretching force being applied to the pelt 1, and the relation between the stretching speed of the pelt 1 and the length of the pelt 1 is illustrated in FIG. 2 as the curve numbered 15. The speed of the stretching reduces as the pelt 1 is stretched and provides more resistance to the stretching. Three curves 16, 17, 18 are included in the diagram disclosing three different embodiment of the present invention, in which the stretching speed is reduced at the last part of the stretching of the pelt 1 so as to provide a more gentle stretching of the pelt 1 and hence the possibility of stretching the pelt 1 further and reach a higher classification size length of the pelt 1. A curve 16 according to a first embodiment of the present invention shows a first constant stretching speed followed by a second, lower but constant stretching speed until the next classification size length Lₙ of the pelt 1 is reached. As two alternatives to this embodiment, one curve 17 is shown where a first constant stretching speed is followed by a down-ramping speed and another curve 18 is shown where the stretching speed is reduced in two consecutive steps. The first stretching speed is in all three embodiments depicted as being constant; in other embodiments of the present invention could the first stretching speed be non-constant, e.g. following a decreasing ramp function.

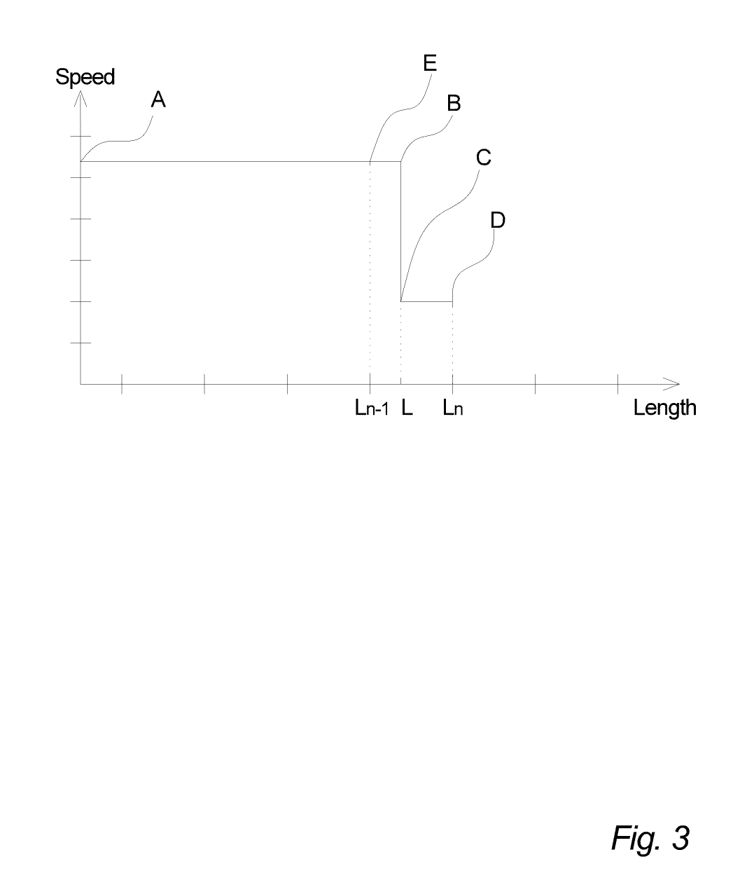

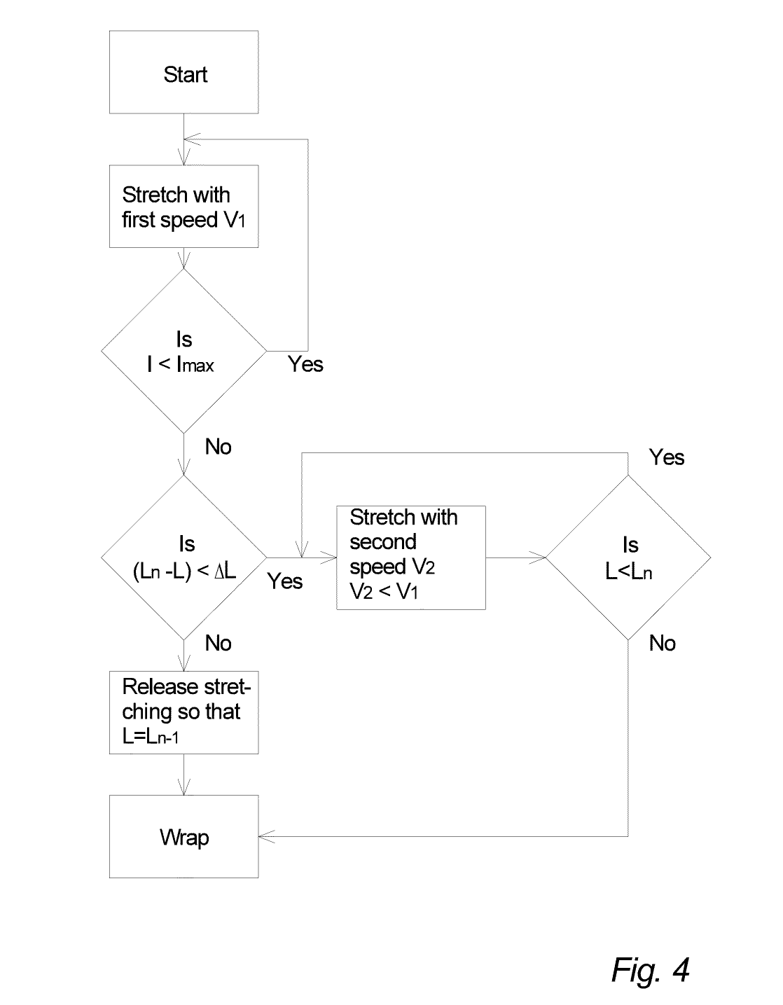

A preferred embodiment of the present invention is illustrated in FIGS. 3 and 4. The pelt 1 is initially placed on the pelt board 2 and its initial non-stretched length is measured to determine a maximum stretching force and hence a maximum drive current Iₘₐₓ. The stretching is started, position A in FIG. 3, and is continued with a constant stretching speed V₁ while the current I of the drive 11 is monitored and reported to the controller 12 which compares the measured current Ito the maximum drive current Iₘₐₓ. When the current I exceeds the maximum current Iₘₐₓ, position B in FIG. 3, the controller compares the stretched length L of the pelt 1 with the set of predefined classification size lengths of pelts, which have a mutual spacing of 60 millimetres to find the closest, longer classification size length Lₙ, computes the difference between the classification size length Lₙ and length of stretched pelt L and compare the difference with a predefined limit ΔL for the difference, e.g. 30 millimetres. If the difference is less than the predefined limit ΔL, the stretching is continued, position C on FIG. 3, with a lower stretching speed V₂ until the length L of the pelt 1 equals the classification size length Lₙ, position D on FIG. 3, where after the fixing strip applier 13 is activated to fixate the pelt 1 to the pelt board 2. In case the computed difference is less than the predefined limit ΔL the stretching is reversed until the length L of the stretched pelt 1 equals the nearest lower classification size length Lₙ₋₁, position E on FIG. 3, where after the fixing strip applier 13 is activated to fixate the pelt 1 to the pelt board 2.

### REFERENCE NUMBERS AND SIGNS

1 Pelt
2 Pelt board
3 Tapering part of pelt board
4 Lower end part of the pelt board with substantially constant cross-section
5 Tip of pelt board
6 Nose end of the pelt
7 Tail end of the pelt
8 Projecting element of pelt board
9 Pelt holders
10 Pelt board holder
11 Driver for driving the pelt board holder towards the pelt holders
12 Controller
13 Fixing strip applier
14 Fixing strip
15 Curve for prior art stretching
16 Curve for first embodiment of stretching
17 Curve for second embodiment of stretching
18 Curve for third embodiment of stretching
L Current length of stretched pelt
Lₙ Next classification size length
Lₙ₋₁ Previous classification size length
ΔL Predefined limit for difference between next classification size length and length of stretched pelt
V₁ Initial stretching speed
V₂ Second stretching speed
I Current in the driver's electric motor
Iₘₐₓ Maximum current in the driver's electric motor corresponding to a maximum stretching force applied to the pelt

1. Apparatus for stretching a pelt on a pelt board comprising
a pelt board holder for holding one end part of the pelt board,
pelt holders arranged to grip at least a part of the lower periphery of the pelt when arranged on the pelt board,
a driver for mutually displacing the pelt board placed in the pelt board holder and the pelt holders in a longitudinal direction of the pelt board so as to stretch the pelt, and
a controller arranged to control the operation of the driver so as to reduce the speed with which the pelt is stretched by means of the driver during stretching of the pelt.

2. The apparatus according to claim 1, comprising at least one detector for detection of at least one parameter associated with the stretching of the pelt and providing an output to the controller, wherein the controller is configured to reduce the speed with which the pelt is stretched in response to said detected parameter(s).

3. The apparatus according to claim 2, wherein said at least one detector(s) is arranged to detect said parameter(s) repeatedly during the stretching of the pelt.

4. The apparatus according to claim 2, wherein one of said parameters is indicative of the current force with which the pelt is being stretched.

5. The apparatus according to claim 2, wherein one of said parameters is indicative of the time during which the pelt has been stretched.

6. The apparatus according to claim 2, wherein one of said parameters is indicative of the current length of the stretched pelt.

7. The apparatus according to claim 2, wherein the controller is arranged to reduce said speed selectively in response to said detected parameter(s).

8. The apparatus according to claim 1, comprising a length detector for detecting a parameter indicative of the current length of the pelt and providing an output accordingly to the controller, wherein the controller is configured to control a first stretching of the pelt by means of the driver and to selectively continuing the stretching of the pelt with a reduced speed relative to the speed with which the pelt was stretched prior to the continued stretching based on said parameter indicative of the current length of the stretched pelt.

9. The apparatus according to claim 8, wherein the controller is configured to continuing the stretching in case the difference between the current length and a selected classification size length is less than a predefined length difference limit, the classification size length being selected from a plurality of predefined classification size lengths as the one being the least longer than the current length.

10. The apparatus according to claim 8, further comprising a force detector for detecting a parameter indicative of the current stretching force applied to the pelt by means of the driver and providing an output accordingly to the controller, wherein the controller is configured to selectively continuing the stretching of the pelt based on said parameter indicative of the current length of the stretched pelt when a defined stretching force has been applied to the pelt.

11. The apparatus according to claim 10, wherein the controller is configured to obtain said defined stretching force for a pelt from a measurement of the length of the pelt before stretching thereof.

12. The apparatus according to claim 1, wherein the controller is configured to reduce the speed with which the pelt is stretched in a step-wise manner.

13. The apparatus according to claim 1, wherein the controller is configured to reduce the speed with which the pelt is stretched in a down-ramping manner.

14. The apparatus according to claim 1, wherein the driver is an electric actuator.

15. A method of stretching a pelt arranged on a pelt board supported at an end part by a pelt board holder, the method comprising the steps of
gripping the lower periphery of the pelt by means of pelt holders,
mutually displacing the pelt board holder and the pelt holders in a longitudinal direction of the pelt board by means of a driver so as to stretch the pelt, and
controlling the stretching of the pelt by means of a controller arranged to control the operation of the driver so that the speed with which the pelt is stretched is reduced during stretching of the pelt.

16. The method according to claim 15 comprising the steps of
conducting a first stretching of the pelt, and
selectively continuing the stretching of the pelt with a reduced speed relative to the speed with which the pelt was stretched prior to the continued stretching based on a parameter indicative of the current length of the stretched pelt.

17. The method according to claim 16, wherein the stretching is continued in case the difference between the current length and a selected classification size length is less than a predefined length difference limit, the classification size length being selected from a plurality of predefined classification size lengths as the one being the least longer than the current length.

18. A method according to claim 15, wherein said pelt is a mink pelt.

19. A method of stretching a pelt arranged on a pelt board supported at an end part by a pelt board holder, the method comprising the steps of
providing an apparatus according to claim 1,
gripping the lower periphery of the pelt by means of the pelt holders,
mutually displacing the pelt board holder and the pelt holders in a longitudinal direction of the pelt board by means of a driver so as to stretch the pelt, and
controlling the stretching of the pelt by means of the controller arranged to control the operation of the driver so that the speed with which the pelt is stretched is reduced during stretching of the pelt.
